(19) United States
(12) Patent Application Publication
(10) Pub. No.: US 2013/0010000 A1
(43) Pub. Date: Jan. 10, 2013

(54) ELECTRONIC DEVICE, STORAGE MEDIUM AND METHOD FOR MANAGING FILES IN THE ELECTRONIC DEVICE

(75) Inventors: HSIAO-PING CHIU, Tu-Cheng (TW); CHUN-TANG HSU, Tu-Cheng (TW); HSUEH-TSEN TSAI, Tu-Cheng (TW); SHU-PING CHEN, Tu-Cheng (TW)

(73) Assignee: HON HAI PRECISION INDUSTRY CO., LTD., Tu-Cheng (TW)

(21) Appl. No.: 13/448,350

(22) Filed: Apr. 16, 2012

(30) Foreign Application Priority Data
Jul. 4, 2011 (TW) 100123561

(51) Int. Cl. G06F 3/041; G09G 5/00

(52) U.S. Cl. 345/676

(57) ABSTRACT

In a method for managing files using an electronic device, the method determines whether a touch operation on a touchscreen corresponds to an icon of a confirmed file. If the touch operation corresponds to the icon of the confirmed file, touch operations of dragging the icon of the confirmed file to an icon of a target folder on the touchscreen are detected. The icon of the confirmed file is controlled to move towards the icon of the target folder and the target folder is confirmed. The confirmed file is stored into the target folder when the target folder is confirmed.

### BACKGROUND

1. Technical Field

The present disclosure relates to management systems and methods, and more particularly to an electronic device, a storage medium and a method for managing files in the electronic device.

2. Description of Related Art

Performing operations on files stored in an electronic device with a touchscreen (e.g. a smart phone with a touchscreen) may be complicated. For example, the files may be stored in a preset storage path automatically, or stored at a target storage position after having to go through folders within folders. It is not intuitive enough and inconveniently for users to store the files in the electronic devices with the touchscreens.

### BRIEF DESCRIPTION OF THE DRAWINGS

FIG. 1 is a block diagram of one embodiment of an electronic device with a file management system.

FIG. 2A, FIG. 2B and FIG. 2C are schematic diagrams for managing an icon of a file and an icon of a target folder displayed in different pages.

FIG. 3A, FIG. 3B, FIG. 3C and FIG. 3D are schematic diagrams for managing an icon of a file and an icon of a target folder displayed in a same page.

FIG. 4 is a flowchart of one embodiment of a method for managing files using the electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

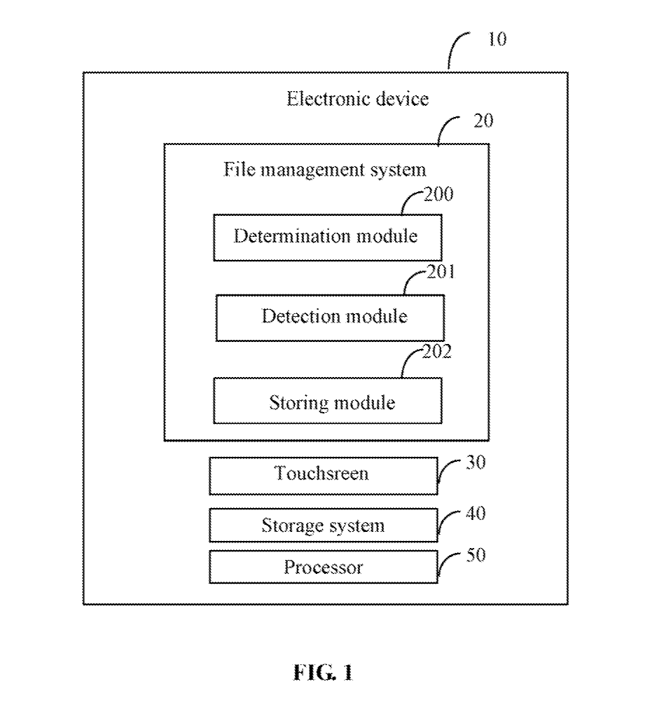

FIG. 1 is a block diagram of one embodiment of an electronic device 10 including a file management system 20. The electronic device 10 further includes a touchscreen 30. The touchscreen 30 may be a capacitive touchscreen or a resistive touchscreen supporting touch operations from a finger or a touch stylus, for example. The electronic device 10 may be a mobile phone, a notebook computer, a personal digital assistant, or any other communication devices. The file management system 20 may manage files to be stored at a target storage position intuitively and conveniently by dragging icons of the files on the touchscreen 30 optionally according to predetermined conditions.

The electronic device 10 further includes a storage system 40 and at least one processor 50. The storage system 40 stores data of the electronic device 10. The storage system 40 may be a memory of the electronic device 10, or an external storage card, such as a smart media card, or a secure digital card. The at least one processor 50 executes one or more computerized codes and other applications of the electronic device 10, to provide the functions of the file arrangement system 20.

In one embodiment, the file management system 20 may include a determination module 200, a detection module 201, and a storing module 202. The modules 200, 201, and 202 comprise computerized codes in the form of one or more programs that are stored in the storage system 40 of the electronic device 10. The computerized code includes instructions that are executed by the at least one processor 50 of the electronic device 10 to provide functions for the modules. Details of these operations follow.

The determination module 200 determines whether a touch operation on the touchscreen 30 corresponds to an icon of a confirmed file displayed on the touchscreen 30. The confirmed file, in one example, can be a file that user desires to be moved from a first storage location to a second storage location. The storage location is a folder including one or more files or other folders in the storage system 40. If the touch operation contacts an icon of one file on the touchscreen 30, the determination module 200 determines that the file is the confirmed file and the touch operation corresponds to the icon of the confirmed file. In one embodiment, the touch operation may be a long single press of a finger or stylus (e.g. contacting the touchscreen 30 for 2 seconds), or a short single press (e.g. contacting the touchscreen 30 for 0.5 seconds) of a finger/stylus contacting the touchscreen 30, for example.

In one embodiment, after the touch operation on the touchscreen 30 is determined to correspond to the icon of the confirmed file, a user can use his/her finger to drag the icon of the confirmed file under direct and continuous contact with the touchscreen 30, for dragging the icon of the confirmed file from an original storage position to a target storage position in the storage system 40. Dragging of the icon of the confirmed file can either be in a linear or non-linear pattern, in some embodiments.

The detection module 201 detects touch operations on the touchscreen 30, and controls the icon of the confirmed file to move towards an icon of a target folder according to the touch operations, in response to determining the touch operation corresponds to the icon of the confirmed file. The touch operations indicate operations of dragging the icon of the confirmed file to the icon of the target folder. The detection module 201 detects continuous touch points of the touch operations from a finger contacting the touchscreen 30 and controls the icon of the confirmed file to move according to the continuous touch points. User can see the icon of the confirmed file move visually.

The detection module 201 further confirms the target folder. In one embodiment, if a last touch point of the touch operations is within a predetermined distance range of one folder (e.g. the last touch point is at an icon of the folder) and a pressing time of the last touch point exceeds a predetermined time limit T (e.g. 2 seconds), the detection module 201 confirms that the folder is the target folder. When a touch point is within the predetermined distance range of the folder, the folder may be highlighted to represent that folder has been chosen to be the target folder. If the last touch point is not within the predetermined distance range of any folder, or the pressing time of the last touch point does not exceed the predetermined time limit T, the confirmed file may be returned to the original storage location, that is, the target folder is not confirmed.

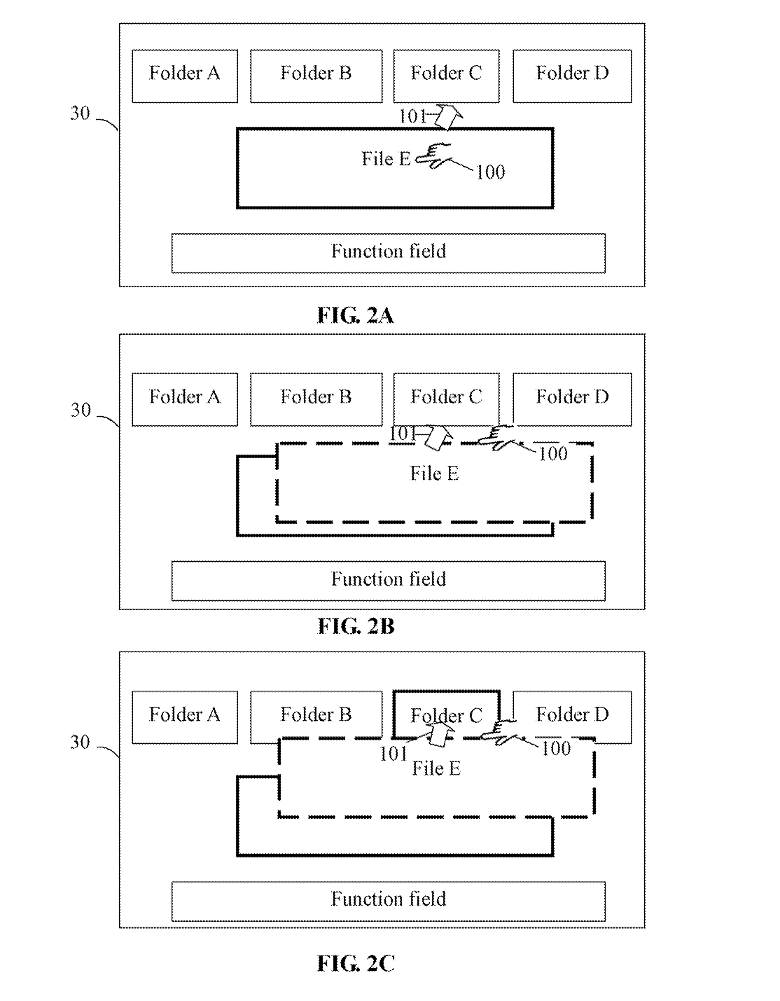

In one embodiment, if the icon of the confirmed file and an icon of the target folder are displayed in the same page on the touchscreen 30, the icon of the confirmed file is dragged to the icon of the target folder directly. FIG. 2A, FIG. 2B and FIG. 2C are schematic diagrams for managing the confirmed file and the target folder displayed in the same page. As shown in FIG. 2A, folder “A”, folder “B”, folder “C”, folder “D” and the file “E” may be under a same storage directory or just displayed in the same page. When the file “E” is the confirmed file and is dragged by means of a finger 100, the icon of the file “E” may be highlighted as shown in FIG. 2A. In FIG. 2B, a move orientation 101 represents an orientation of touch operations of dragging the icon of the file “E”. The move orientation 101 in FIG. 2B is towards the icon of the folder “C”, that is, the folder “C” may be regarded as the target folder.

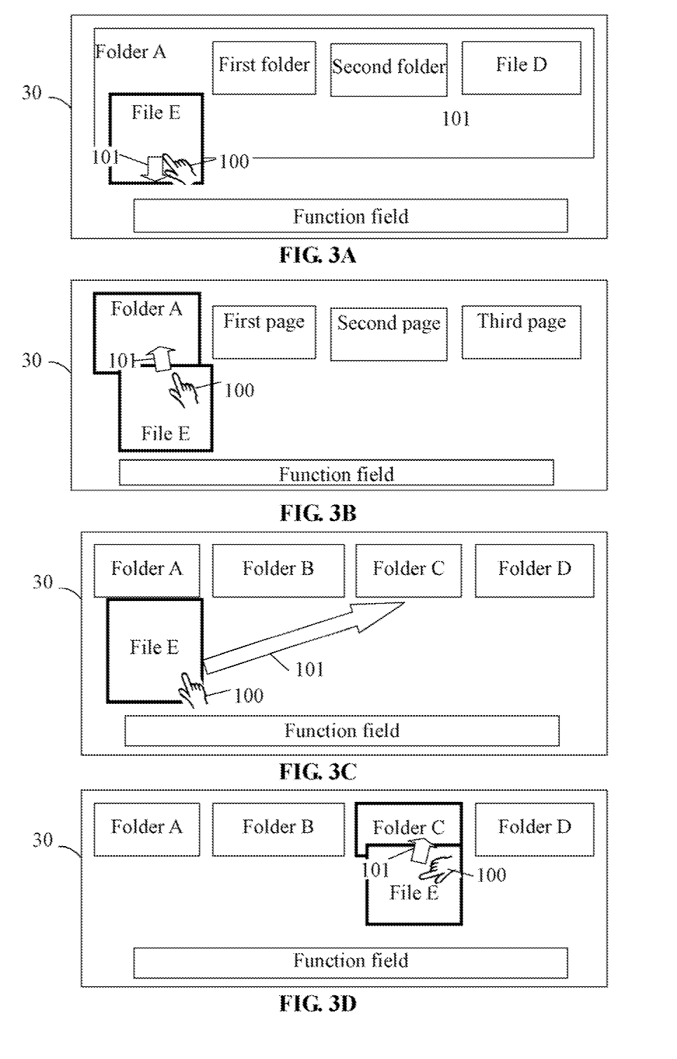

If the icon of the confirmed file and the icon of the target folder are in the different pages, the icon of the confirmed file needs to be dragged out from one or more previous folders until the icon of the confirm file and the icon of the target folder are in the same page, and then dragged to the icon of the target folder. In one embodiment, if the icon of the confirmed file is displayed in a previous folder, the icon of the confirmed file is dragged to an edge of the range of the previous folder for dragging the icon of the confirmed file out from the previous folder. As shown in FIG. 3A, the folder “A” includes a file “E”, a first folder, a second folder and a file “D”, and the icon of the file “E” is displayed in the folder “A”. When the file “E” is the confirmed file and is dragged through the finger 100, the icon of the file “E” may be highlighted as shown in FIG. 3A. If the icon of the file “E” is selected to drag, the icon of the file “E” is firstly dragged to an edge of the range of the folder “A”.

If the icon of the confirmed file and an icon of the previous folder are displayed in the same page, the icon of the confirmed file is dragged to be at the icon of the previous folder for a predetermined time duration (e.g. 2 seconds), for dragging the icon of the confirmed file out from the previous folder. That is, if a touch point (not the last touch point) of the touch operations contacts an icon of one folder and a pressing time of the touch point exceeds a predetermined time duration, the detection module 201 confirms that the icon of the confirmed file needs to be dragged out from the previous folder. As shown in FIG. 3B, the folder “A” includes a file “E”, a first page, a second page and a third page”, and the icon of file “E” and the icon of the folder “A” are displayed in a same page. When the file “E” is the confirmed file and is dragged through the finger 100, the icon of the file “E” may be highlighted as shown in FIG. 3B. If the icon of the file “E” is selected to drag, the icon of the file “E” is firstly dragged to be at the icon of the folder “A” for the predetermined time duration.

When the icon of the confirmed file is confirms to be dragged out from the previous folder, the detection module 201 returns to a parent directory of the previous folder and displays icons of folders in the parent directory including the icon of the confirmed file on the touchscreen 30. As shown in FIG. 3C, a parent directory of the folder “A” including a folder “B”, a folder “C” and a folder “D”. When the icon of the file “E” in the FIG. 3A or in the FIG. 3B is selected to be dragged out from the folder “A”, icons of the folders in the parent directory of the folder “A” including the icon of the file “E” are displayed as shown in FIG. 3C. In FIG. 3D, the move orientation in FIG. 3D is towards the icon of the folder “C”, that is, the folder “C” is the target folder.

The storing module 202 stores the confirmed file into the target folder when the target folder is confirmed. In one embodiment, the storing module 202 may store the confirmed file under a storage path of the target file in the storage system 40. In FIG. 2C and FIG. 3D, if the last touch point of the touch operations is within a predetermined distance range of the folder “C” and the pressing time of the last touch point exceeds the predetermined time limit, the detection module 201 determines that the folder “C” is the target folder, and the storing module 202 stores the file “E” into the folder “C”.

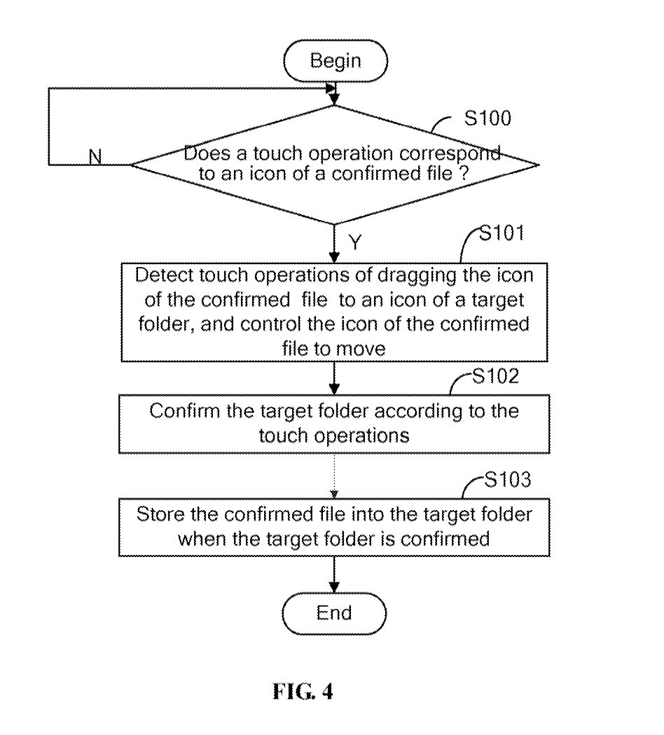

FIG. 4 is a flowchart of one embodiment of a method for managing files using the electronic device of FIG. 1. Depending on the embodiment, additional blocks may be added, others deleted, and the ordering of the blocks may be changed.

In block S100, the determination module 200 determines whether a touch operation on the touchscreen 30 corresponds to an icon of a confirmed file displayed on the touchscreen 30. The confirmed file, in one example, can be a file that user desires to be moved from a first storage location to a second storage location. The storage location is a folder including one or more files or other folders in the storage system 40. If the touch operation contacts an icon of one file on the touchscreen 30, the determination module 200 determines that the file is the confirmed file and the touch operation corresponds to the icon of the confirmed file. In one embodiment, the touch operation may be a long single press of a finger or stylus (e.g. contacting the touchscreen 30 for 2 seconds), or a short single press (e.g. contacting the touchscreen 30 for 0.5 seconds) of a finger/stylus contacting the touchscreen 30, for example. If the touch operation corresponds to the icon of the confirmed file, block S101 is implemented. If the touch operation does not correspond to the icon of the confirmed file, block S100 is repeated.

In one embodiment, after the touch operation on the touchscreen 30 is determined to correspond to the icon of the confirmed file, a user can use his/her finger to drag the icon of the confirmed file under direct and continuous contact with the touchscreen 30, for dragging the icon of the confirmed file from an original storage position to a target storage position in the storage system 40. Dragging of the icon of the confirmed file can either be in a linear or non-linear pattern, in some embodiments.

In block S101, the detection module 201 detects touch operations on the touchscreen 30, and controls the icon of the confirmed file to move towards an icon of a target folder according to the touch operations. If the icon of the confirmed file and the icon of the target folder are in the different pages, the icon of the confirmed file needs to be dragged out from one or more previous folders until the icon of the confirm file and the icon of the target folder are in the same page, and then dragged to the icon of the target folder. In one embodiment, if the icon of the confirmed file is displayed in a previous folder, the icon of the confirmed file is dragged to an edge of the range of the previous folder for dragging the icon of the confirmed file out from the previous folder. If the icon of the confirmed file and an icon of the previous folder are displayed in the same page, the icon of the confirmed file is dragged to be at the icon of the previous folder for a predetermined time duration (e.g. 2 seconds), for dragging the icon of the confirmed file out from the previous folder. When the When the icon of the confirmed file is confirms to be dragged out from the previous folder, the detection module 201 returns to a parent directory of the previous folder and displays icons of folders in the parent directory including the icon of the confirmed file on the touchscreen 30.

In block S102, the detection module 201 confirms the target folder according to the touch operations. In one embodiment, if a last touch point of the touch operations is within a predetermined distance range of one folder (e.g. the last touch point is at an icon of the folder) and a pressing time of the last touch point exceeds a predetermined time limit T (e.g. 2 seconds), the detection module 201 confirms that the folder is the target folder. When a touch point is within the predetermined distance range of the folder, the folder may be highlighted to represent that folder has been chosen to be the target folder. If the last touch point is not within the predetermined distance range of any folder, or the pressing time of the last touch point does not exceed the predetermined time limit T, the confirmed file may be returned to the original storage location, that is, the target folder is not confirmed.

In block S103, the storing module 202 stores the confirmed file into the target folder when the target folder is confirmed. In one embodiment, the storing module 202 may store the confirmed file under a storage path of the target file in the storage system 40.

All of the processes described above may be embodied in, and be fully automated via, functional code modules executed by one or more general-purpose processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

The described embodiments are merely possible examples of implementations, and have been set forth for a clear understanding of the principles of the present disclosure. Many variations and modifications may be made without departing substantially from the spirit and principles of the present disclosure. All such modifications and variations are intended to be included herein within the scope of this disclosure and the described inventive embodiments, and the present disclosure is protected by the following claims.

What is claimed is:

1. A computer-implemented method for managing files using an electronic device, the method comprising:
determining whether a touch operation on a touchscreen of the electronic device corresponds to an icon of a confirmed file that is displayed on the touchscreen;
in response to determining that the touch operation corresponds to the icon of the confirmed file, detecting touch operations on the touchscreen indicative of operations of dragging the icon of the confirmed file to an icon of a target folder in a storage system of the electronic device on the touchscreen;
controlling the icon of the confirmed file to move towards the icon of the target folder according to the touch operations;
confirming the target folder according to the touch operations; and
storing the confirmed file into the target folder.

2. The method as claimed in claim 1, wherein the touch operation is a long single press or a short single press of a finger or stylus contacting the touchscreen.

3. The method as claimed in claim 1, wherein a folder is confirmed to be the target folder upon the condition that a last touch point of the touch operations is within a predetermined distance range of the folder and a pressing time of the last touch point exceeds a predetermined time limit.

4. The method as claimed in claim 3, wherein the folder is highlighted upon the condition that the touch point of the touch operations is within the predetermined distance range of the folder.

5. The method as claimed in claim 1, further comprising:
returning to a parent directory of a previous folder in the storage system and displays icons of folders in the parent directory comprising the icon of the confirmed file on the touchscreen, if the icon of the confirmed file and the icon of the target folder are in the different pages and the icon of the confirmed file is dragged out from the previous folder.

6. The method as claimed in claim 5, wherein the icon of the confirmed file is dragged out from the previous folder by determining that the icon of the confirmed file is dragged to an edge of a range of the previous folder if the icon of the confirmed file is displayed in the previous folder, or by determining that the icon of the confirmed file is dragged to be at the icon of the previous folder for a predetermined time duration if the icon of the confirmed file and an icon of the previous folder are displayed in the same page.

7. A non-transitory computer readable storage medium storing a set of instructions, when executed by at least one processor of an electronic device, cause the at least one processor to perform a method for managing files using the electronic device, the method comprising:
determining whether a touch operation on a touchscreen of the electronic device corresponds to an icon of a confirmed file that is displayed on the touchscreen;
in response to determining that the touch operation corresponds to the icon of the confirmed file, detecting touch operations on the touchscreen indicative of operations of dragging the icon of the confirmed file to an icon of a target folder in a storage system of the electronic device on the touchscreen;
controlling the icon of the confirmed file to move towards the icon of the target folder according to the touch operations;
confirming the target folder according to the touch operations; and
storing the confirmed file into the target folder.

8. The non-transitory computer readable storage medium as claimed in claim 7, the touch operation is a long single press or a short single press of a finger or stylus contacting the touchscreen.

9. The non-transitory computer readable storage medium as claimed in claim 7, wherein a folder is confirmed to be the target folder upon the condition that a last touch point of the touch operations is within a predetermined distance range of the folder and a pressing time of the last touch point exceeds a predetermined time limit.

10. The non-transitory computer readable storage medium as claimed in claim 9, wherein the folder is highlighted upon the condition that the touch point of the touch operations is within the predetermined distance range of the folder.

11. The non-transitory computer readable storage medium as claimed in claim 7, further comprising:
returning to a parent directory of a previous folder in the storage system and displays icons of folders in the parent directory comprising the icon of the confirmed file on the touchscreen, if the icon of the confirmed file and the icon of the target folder are in the different pages and the icon of the confirmed file is dragged out from the previous folder.

12. The non-transitory computer readable storage medium as claimed in claim 11, wherein the icon of the confirmed file is dragged out from the previous folder by determining that the icon of the confirmed file is dragged to an edge of a range of the previous folder if the icon of the confirmed file is displayed in the previous folder, or
by determining that the icon of the confirmed file is dragged to be at the icon of the previous folder for a predetermined time duration if the icon of the confirmed file and an icon of the previous folder are displayed in the same page.

13. An electronic device, comprising:
a touchscreen;
a storage system;
at least one processor; and
one or more programs that are stored in the storage system and executed by the at least one processor, the one or more programs comprising:
a determination module that determines determining whether a touch operation on the touchscreen corresponds to an icon of a confirmed file that is displayed on the touchscreen;
a detection module that detects touch operations on the touchscreen indicative of operations of dragging the icon of the confirmed file to an icon of a target folder in the storage system on the touchscreen, in response to determining that the touch operation corresponds to the icon of the confirmed file;
the detection module further controls the icon of the confirmed file to move towards the icon of the target folder according to the touch operations, and confirms the target folder according to the touch operations;
a storing module that stores the confirmed file into the target folder when the target folder is confirmed.

14. The electronic device as claimed in claim 13, wherein the touch operation is a long single press or a short single press of a finger or stylus contacting the touchscreen.

15. The electronic device as claimed in claim 13, wherein the detection module confirms a folder is confirmed to be the target folder upon the condition that a last touch point of the touch operations is within a predetermined distance range of the folder and a pressing time of the last touch point exceeds a predetermined time limit.

16. The electronic device as claimed in claim 15, wherein the folder is highlighted upon the condition that the touch point of the touch operations is within the predetermined distance range of the folder.

17. The electronic device as claimed in claim 13, wherein the detection module further returns to a parent directory of a previous folder in the storage system and displays icons of folders in the parent directory comprising the icon of the confirmed file on the touchscreen, if the icon of the confirmed file and the icon of the target folder are in the different pages and the icon of the confirmed file is dragged out from the previous folder.

18. The electronic device as claimed in claim 17, wherein the icon of the confirmed file is dragged out from the previous folder by determining that the icon of the confirmed file is dragged to an edge of a range of the previous folder if the icon of the confirmed file is displayed in the previous folder, or by determining that the icon of the confirmed file is dragged to be at the icon of the previous folder for a predetermined time duration if the icon of the confirmed file and an icon of the previous folder are displayed in the same page.
